(19) United States
(12) Patent Application Publication
(10) Pub. No.: US 2010/0029360 A1
(43) Pub. Date: Feb. 4, 2010

(54) GAMING SYSTEM AND A METHOD OF GAMING

(75) Inventor: George Roukis, Miranda (AU)

Correspondence Address: HANLEY, FLIGHT & ZIMMERMAN, LLC, 150 S. WACKER DRIVE, SUITE 2100, CHICAGO, IL, 60606, US

(73) Assignee: Aristocrat Technologies Australia Pty Limited, North Ryde (AU)

(21) Appl. No.: 12/361,317

(22) Filed: Jan. 28, 2009

(30) Foreign Application Priority Data
Jan. 29, 2008 (AU) 2008900384

(51) Int. Cl. A63F 9/24; A63F 13/00

(52) U.S. Cl. 463/17; 463/30; 463/43

(57) ABSTRACT

The present disclosure provides a gaming system which includes a player symbol selector arranged to select player symbols from a plurality of player symbols. The player symbols include at least one special player symbol. Further, the gaming system comprises a display having a plurality of individual display positions for displaying at least one selected player symbol. The gaming system also includes a display position selector arranged to select at least one of the individual display position when the at least one special player symbol is displayed. In addition, the gaming system includes a reward allocator arranged to allocate a reward when the display position selector selects an individual display position at which the at least one special player symbol is displayed.

### CROSS-REFERENCE TO RELATED APPLICATIONS

The present application claims the benefit of priority to Australian Provisional Patent Application No. 2008900384, filed on Jan. 29, 2008, entitled “A GAMING SYSTEM AND A METHOD OF GAMING”, which is herein incorporated by reference in its entirety.

### FIELD OF THE INVENTION

The present invention broadly relates to a gaming system and method of gaming.

### BACKGROUND OF THE INVENTION

Video gaming machines, such as poker or slot machines, are widely used in many countries. Such gaming machines typically have a video display that simulates a number of spinning reels. Each reel has a number of player symbols and a selection of the player symbols is displayed on the display when the simulated reels cease spinning.

The displayed player symbols typically are displayed in an array of display positions on the video display. If the displayed player symbols correspond to a predefined wining combination of player symbols, the player wins a prize. Typically, the winning combination includes two or more of the player symbols displayed along a “win line”, which is a predefined imaginary line through adjacent display positions.

In addition, some gaming machines offer the chance to win a Jackpot prize, which typically is a relatively large prize.

### SUMMARY OF THE INVENTION

The present invention provides in a first aspect a gaming system including:

a player symbol selector arranged to select player symbols from a plurality of player symbols, the player symbols including at least one special player symbol;

a display having a plurality of individual display positions for displaying at least one selected player symbol;

a display position selector arranged to select at least one of the individual display position when the at least one special player symbol is displayed; and

a reward allocator arranged to allocate a reward when the display position selector selects an individual display position at which the at least one special player symbol is displayed.

In one specific embodiment of the present invention the display position selector is arranged for activation by a player when the at least one special player symbol is displayed.

Alternatively, the display position selector may be arranged for pre-activation by the player prior to display of the at least one special player symbol, so that, when the at least one special player symbol is displayed, the display position selector automatically selects an individual display position.

In a further variation the display position selector may be activated or pre-activated by an event, such as display of a particular player symbol or a credit point level that is reached.

The at least one special player symbol may be a Jackpot symbol. The at least one special player symbol may also be associated with a Jackpot level. The reward allocator may be arranged to allocate a Jackpot or Jackpot level when the at least one special player symbol is displayed at a display position and that display position is selected by the display position selector.

The display position selector may be arranged to select any one of the individual display positions.

Alternatively, the display position selector may be arranged so that the player can choose a group of display positions within which the display position selector selects an individual display position.

The display may include an array of individual display positions. The gaming system may be arranged so that the player has the opportunity to activate or pre-activate the display position selector and choose one or more of the columns or rows of the array of display positions from which the display position selector selects the individual display position.

The display position selector may be arranged for activation or pre-activate by operating a manual control, such as a control button that is accessible to the player. For example, the gaming system may include a plurality of manual controls that are accessible to the player and that are associated with respective individual display position groups. Each manual control may be located adjacent a respective display position group, such as adjacent a respective column or row of the individual display positions.

The gaming system may be arranged so that the activation or pre-activation of the display position selector can be purchased by the player.

The display may be arranged to display a feature symbol when the display position selector is activated or pre-activated and/or when the at least one special player feature symbol is displayed.

The display may be arranged so that, when the display position selector selects an individual display position, a marking symbol is displayed at that display position. The marking symbol and the at least one special player symbol may be associated with each other. Further, the feature symbol may be associated with the special player symbol and the at least one marking symbol.

In one specific example the at least one special player symbol is a representation of a military symbol, such as a military ship, tank or the like. The feature symbol may be a further military symbol, such as a representation of a military plane, ship, tank or the like.

The gaming system may be arranged to visualize the selection by the display position selector, which may include displaying the feature symbol as moving across at least some of the individual display positions.

In one specific example the feature symbol is a representation of a military object, such as a plane, and the gaming system is arranged to display a representation of a projectile on the individual display position that is selected by the display position selector. The gaming system may be arranged to display an explosion of the projectile or mark the selected individual display position in another way when the special player symbol is displayed.

The present invention provides in a second aspect a method of gaming including:

selecting player symbols from a plurality of player symbols, the player symbols including at least one special player symbol;

displaying at least one selected player symbol on a display having a plurality of individual display positions;

selecting at least one of the individual display position when the at least one special player symbol is displayed; and

allocating a reward when an individual display position, at which the at least one special player symbol is displayed, is selected.

The step of selecting at least one individual display position may include activation of a display position selector by a player when the at least one special player symbol is displayed.

Alternatively, the step of selecting at least one individual display position may include pre-activation of the display position selector by a player prior to display of the at least one special player symbol, so that, when the at least one special player symbol is displayed, the display position selector automatically selects an individual display position.

In a further variation the step of selecting at least one individual display position may include activation or pre-activation of the display position selector by an event, such as display of a particular player symbol or a credit point level that is reached.

The at least one special player symbol may be a Jackpot symbol. The at least one special player symbol may also be associated with a Jackpot level. The method may include allocating a Jackpot or Jackpot level when the at least one special player symbol is displayed and the respective display position is selected by the display position selector.

The step of selecting at least one individual display position may include selecting any one of the individual display positions. Alternatively, the step of selecting at least one display position display position may include choosing a group of display positions within which the display position selector will select the at least one individual display position when the at least one special player symbol is displayed within that group of individual display positions.

The step of selecting at least one display position may also include activation or pre-activate by operating a manual control, such as a control button that is accessible to the player.

The method may include the step of displaying a feature symbol when the at least one special player symbol is displayed. In addition, the method may include the step of displaying a marking symbol at the at least one selected individual display position. The marking symbol and the at least one special player symbol may be associated with each other. Further, the feature symbol may be associated with the special player symbol and the marking symbol.

The present invention provides in a third aspect a computer program for instructing a computer and arranged so that, when loaded in the computer, the computer operates as a gaming system in accordance with the first aspect of the present invention.

The present invention provides in a fourth aspect a computer readable medium having a computer readable program code embodied therein for causing a computer medium to operate as a gaming system in accordance with the first aspect of the present invention.

The present invention provides in a fifth aspect a computer that is arranged for operation in accordance with the gaming system as defined by the first aspect of the present invention.

The present invention provides in a sixth aspect a data signal having a computer readable program code embodied therein and that is arranged to operate for causing a computer to operate in accordance with the gaming system of the first aspect of the present invention.

### BRIEF DESCRIPTION OF THE DRAWINGS

The invention will be more fully understood from the following description of specific embodiments of the invention. The description is provided with reference to the accompanying drawings.

FIG. 1 is a diagrammatic block diagram of a gaming system in accordance with an embodiment of the present invention;

FIG. 2 is a diagrammatic representation of a gaming system in accordance with an embodiment of the present invention with the gaming system implemented in the form of a stand alone gaming machine;

FIG. 3 is a schematic block diagram of operative components of the gaming machine shown in FIG. 2;

FIG. 4 is a schematic block diagram of components of a memory of the gaming machine shown in FIG. 2;

FIG. 5 is a schematic diagram of a gaming system in accordance with an alternative embodiment of the present invention with the gaming system implemented over a network;

FIG. 6 is a flow diagram illustrating a method of gaming in accordance with an embodiment of the present invention; and

FIGS. 7 to 10 are representations of displays of a gaming system in accordance with embodiments of the present invention.

The foregoing summary, as well as the following detailed description of certain embodiments of the present invention, will be better understood when read in conjunction with the appended drawings. For the purpose of illustrating the invention, certain embodiments are shown in the drawings. It should be understood, however, that the present invention is not limited to the arrangements and instrumentality shown in the attached drawings.

### DETAILED DESCRIPTION OF CERTAIN EMBODIMENTS

Embodiments of the present invention generally concern a gaming system that includes a player symbol selector which is arranged to select player symbols from a plurality of player symbols. The player symbols include special player symbols which may be provided in the form of Jackpot symbols. The gaming system also includes a display having a plurality of individual display positions for displaying the at least one selected player symbol.

Further, the gaming system includes a display position selector that is arranged to select at least one of the individual display positions when the at least one special player symbol is displayed. In addition, the gaming system includes a reward allocator arranged to allocate a reward when the display position selector selected an individual display position at which the at least one special player symbol is displayed.

In one embodiment the display position selector is activatable by a player. When the at least one special player symbol is displayed, the player has the opportunity to activate the display position selector.

In an alternative embodiment the display position selector is pre-activatable by the player. When the at least one special player symbol is displayed, the display position selector automatically selects an individual display position.

The gaming system according to an embodiment of the present invention also includes an accumulator for accumulation of the win or credit points. The gaming system may be arranged so that a reward, such as a Jackpot prize, is allocated once a predefined number of the win or credit points have been accumulated.

The plurality of special player symbols may include at least one special player symbol for which more credit points are awarded, when that special player symbol is displayed and the respective display position is selected by the display position selector, than for another one of the special player symbols. For example, the special player symbols may include a number of special player symbols for which different amounts of credit points are awarded when those special player symbols are displayed and the respective display positions are selected by the display position selector.

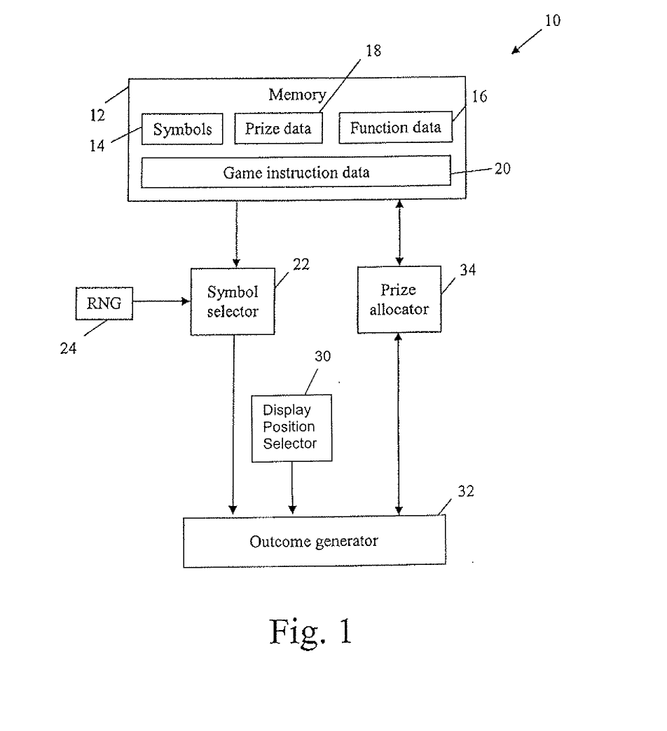

Referring now to FIG. 1, a gaming system according to an embodiment of the present invention is described. The gaming system 10 includes a memory 12 arranged to store player symbol data 14 indicative of a plurality of player symbols for selection and display to a player during a game, function data 16 indicative of one or more functions associated with one or more of the player symbols, prize data 18 indicative of prize amounts associated with win outcomes for reaching each level of the game, and game instruction data 20 indicative of game instructions usable by the gaming machine 10 to control operation of the game.

The gaming system 10 also includes a player symbol selector 22 which is arranged to select the player symbols for display to a player, in this example using a random number generator 24. The player symbols include at least one special player symbol.

Alternatively, the gaming system 10 may further include a dedicated selector that only selects special player for display to the player. In this case the selector 22 is arranged to select player symbols that are not special player symbols.

It will be appreciated that the random number generator 24 may be of a type which is arranged to generate pseudo random numbers based on a seed number, and that in this specification the term “random” will be understood accordingly to mean truly random or pseudo random.

The gaming system 10 also includes a display position selector 30 that is arranged to select at least one individual display position when the at least one special player symbol is displayed at anyone of the display positions or at anyone of a group of the display positions. The gaming system 10 is arranged so that a reward is allocated when the special player symbol is displayed and the display position selector 30 selects the display position at which the special player symbol is displayed.

The display position selector 30 is in this example controllable by the player. The display position selector 30 is arranged so that the player has the option to activate the display position selector 30 once the special player symbol is displayed. The activation of the display position selector 30 can be purchased by the player.

Alternatively, the display position selector 30 may be pre-activated by the player. Once the special symbol is displayed, the display position selector 30 will then automatically select a display position.

The gaming system 10 also includes a prize allocator 34 which communicates with the prize data 18 stored in the memory 12, with the display position selector 30 and with the outcome generator 30, and determines an appropriate prize to allocate to a player.

Prizes may be allocated on the basis of occurrence of a particular player symbols, a consecutive sequence such as 1, 2, 3, occurrence of odd or even numbers, occurrence of the same symbol combination and so on.

A Jackpot prize may be won if the display position selector 30 selects a number of the display positions at which special player symbols are displayed, for example in a number of successive games. Each special player symbol may be a Jackpot level symbol and in this embodiment the prize allocator 34 includes an accumulator that accumulates win points that are associated with the Jackpot levels. Once a predefined level of win points or a predefined Jackpot level is reached, the prize allocator 34 allocates the Jackpot prize.

The prize allocator 34 may also be arranged to award monetary prizes, tokens, progressive prizes, eligibility for feature games, tournament entitlements, or special symbol entitlements in other games, such as an additional wild symbol for a predefined number of games. As described above, the gaming system 10 may be arranged so that win points or the like are contributed to a progressive Jackpot.

In the embodiment described below, the symbol selector 22, the display position selector 30 and the prize allocator 34 are implemented using a microprocessor and associated programs, although it will be understood that other implementations are envisaged.

The gaming system 10 can take a number of different forms.

In a first form, a stand alone gaming machine is provided wherein all or most components implementing the game are present in a player operable gaming machine.

In a second form, a distributed architecture is provided wherein some of the components implementing the game are present in a player operable gaming machine and some of the components implementing the game are located remotely relative to the gaming machine. For example, a “thick client” architecture may be used wherein part of the game is executed on a player operable gaming machine and part of the game is executed remotely, such as by a gaming server; or a “thin client” architecture may be used wherein most of the game is executed remotely such as by a gaming server and a player operable gaming machine is used only to display audible and/or visible gaming information to the player and receive gaming inputs from the player.

However, it will be understood that other arrangements are envisaged. For example, an architecture may be provided wherein a gaming machine is networked to a gaming server and the respective functions of the gaming machine and the gaming server are selectively modifiable. For example, the gaming system may operate in stand alone gaming machine mode, “thick client” mode or “thin client” mode depending on the game being played, operating conditions, and so on. Other variations will be apparent to persons skilled in the art.

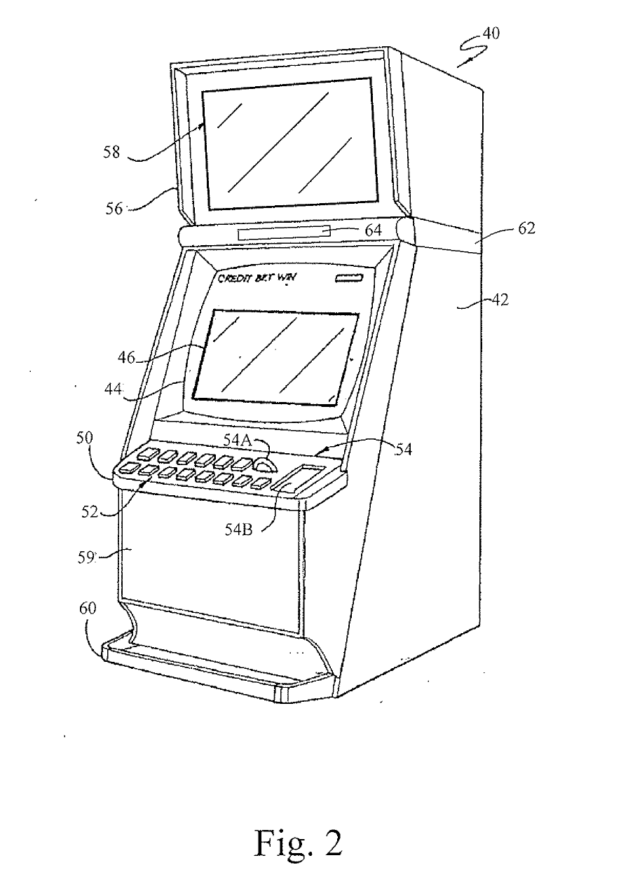

A gaming system in the form of a stand alone gaming machine 40 is illustrated in FIG. 2. The gaming machine 40 includes a console 42 having a display 44 on which is displayed representations of a game 46 that can be played by a player. A mid-trim 50 of the gaming machine 40 houses a bank of buttons 52 for enabling a player to interact with the gaming machine during the game, activate or preactivate the display position selector 30, place bats or select win lines. The mid-trim 50 also houses a credit input mechanism 54 which in this example includes a coin input chute 54A and a bill collector 54B. Other credit input mechanisms may also be employed, for example, a card reader for reading a smart card, debit card or credit card.

A top box 56 may carry artwork 58, including for example pay tables and details of bonus awards and other information or images relating to the game. Further artwork and/or information may be provided on a front panel 59 of the console 42. A coin tray 60 is mounted beneath the front panel 59 for dispensing cash payouts from the gaming machine 40.

A player tracking module (PTM) 62 having a display 64 is connected to the gaming machine 40. The main purpose of the PTM 62 is to allow the player to interact with a player loyalty system. The PTM has a magnetic card reader for the purpose of reading a player tracking device, for example as part of a loyalty program. However other reading devices may be employed and the player tracking device may be in the form of a card, flash drive or any other portable storage medium capable of being read by the reading device. In this example, the PTM 62 is a Sentinel III device produced by Aristocrat Technologies Pty Ltd.

In one embodiment, the PTM 62 includes a touch screen and the display 64 of the PTM 62 is used to display the feature game including directional controls used by a player to control movement of an object during the feature game, which movable object may be displayed on the primary or secondary displays 44, 58, or elsewhere.

The display 44 is in the form of a video display unit, particularly a cathode ray tube screen device. Alternatively, the display 44 may be a liquid crystal display, plasma screen, any other suitable video display unit. The top box 56 may also include a display, for example a video display unit, which may be of the same type as the display 44, or of a different type.

The display 44 in this example is arranged to show an array having rows and columns of individual display positions, which represent several reels, each reel of which has several associated symbols. Typically 3, 4 or 5 reels are represented.

The mid-trim 50 also includes control elements 55 that are provided in the form of control buttons and that are arranged so that a player can activate or pre-activate the display position selector 30 to select a display position within a respective column of display positions of the display 44. It is to be appreciated by a person skilled in the art that the control elements may alternatively also be positioned at any other suitable position.

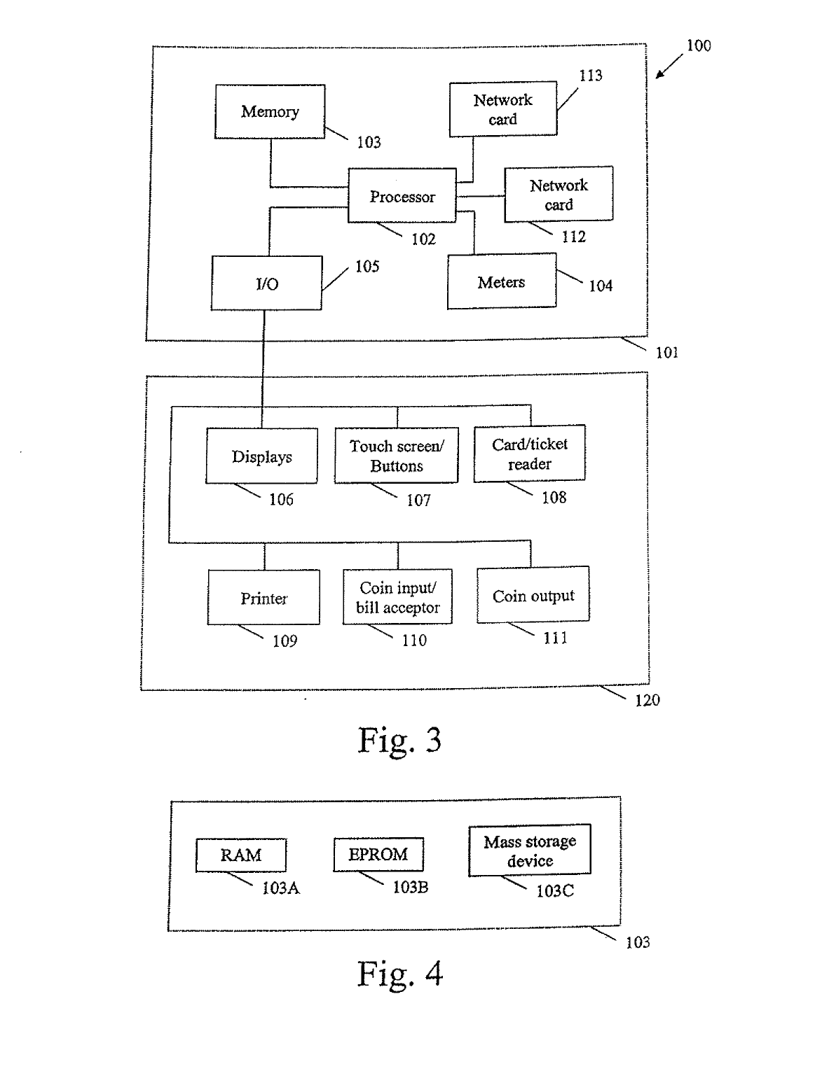

FIG. 3 shows a block diagram of operative components of a typical gaming machine 100 which may be the same as or different to the gaming machine shown in FIG. 2.

The gaming machine 100 includes a game controller 101 having a processor 102. Instructions and data to control operation of the processor 102 are stored in a memory 103 which is in data communication with the processor 102.

Typically, the gaming machine 100 will include both volatile and non-volatile memory and more than one of each type of memory, with such memories being collectively represented by the memory 103.

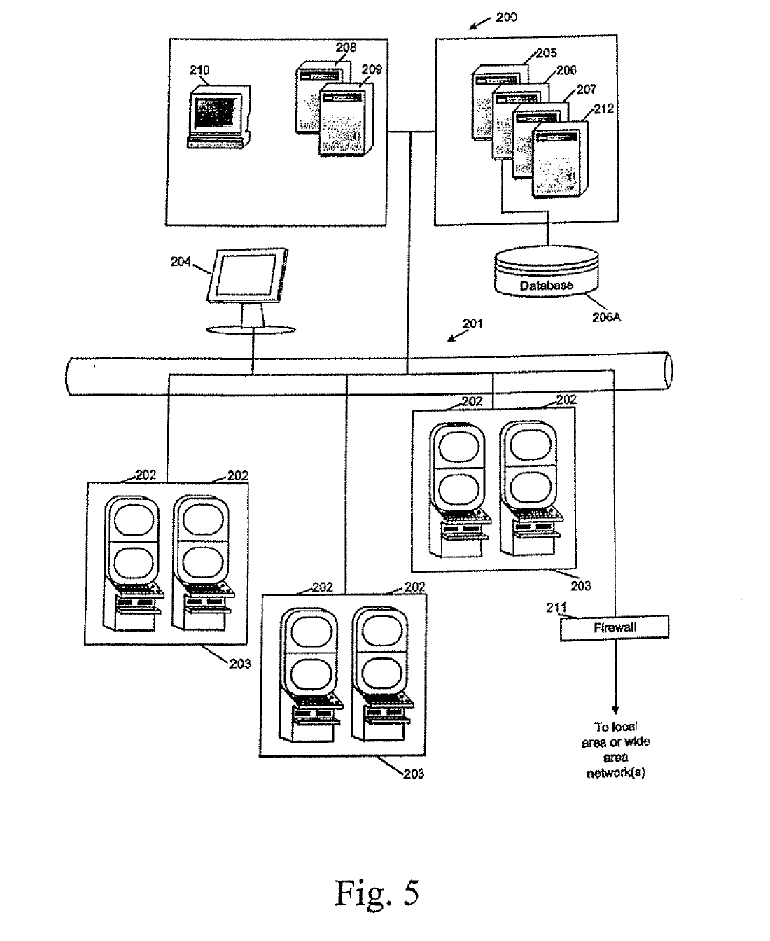

FIG. 4 shows a block diagram of the main components of an exemplary memory 103. The memory 103 includes RAM 103A, EPROM 103B and a mass storage device 103C. The RAM 103A typically temporarily holds program files for execution by the processor 102 and related data. The EPROM 103B may be a boot ROM device and/or may contain some system or game related code. The mass storage device 103C is typically used to store game programs, the integrity of which may be verified and/or authenticated by the processor 102 using protected code from the EPROM 103B or elsewhere, and data indicative of symbols, prize amounts and symbol functions used in the game.

The gaming machine has hardware meters 104 for purposes including ensuring regulatory compliance and monitoring player credit, an input/output (I/O) interface 105 for communicating with a player interface 120 of the gaming machine 100, the player interface 120 having several peripheral devices. The input/output interface 105 and/or the peripheral devices may be intelligent devices with their own memory for storing associated instructions and data for use with the input/output interface or the peripheral devices. A random number generator module 113 generates random numbers for use by the processor 102.

In the example shown in FIG. 3, the peripheral devices that communicate with the game controller 101 include one or more displays 106, a touch screen and/or bank of buttons 107, a card and/or ticket reader 108, a printer 109, a bill acceptor and/or coin input mechanism 110 and a coin output mechanism 111. Additional hardware may be included as part of the gaming machine 100, or hardware may be omitted based on the specific implementation.

In addition, the gaming machine 100 may include a communications interface, for example a network card 112. The network card may, for example, send status information, accounting information or other information to a central controller, server or database and receive data or commands from the central controller, server or database.

It is also possible for the operative components of the gaming machine 100 to be distributed, for example input/output devices 106,107,108,109,110,111 may be provided remotely from the game controller 101.

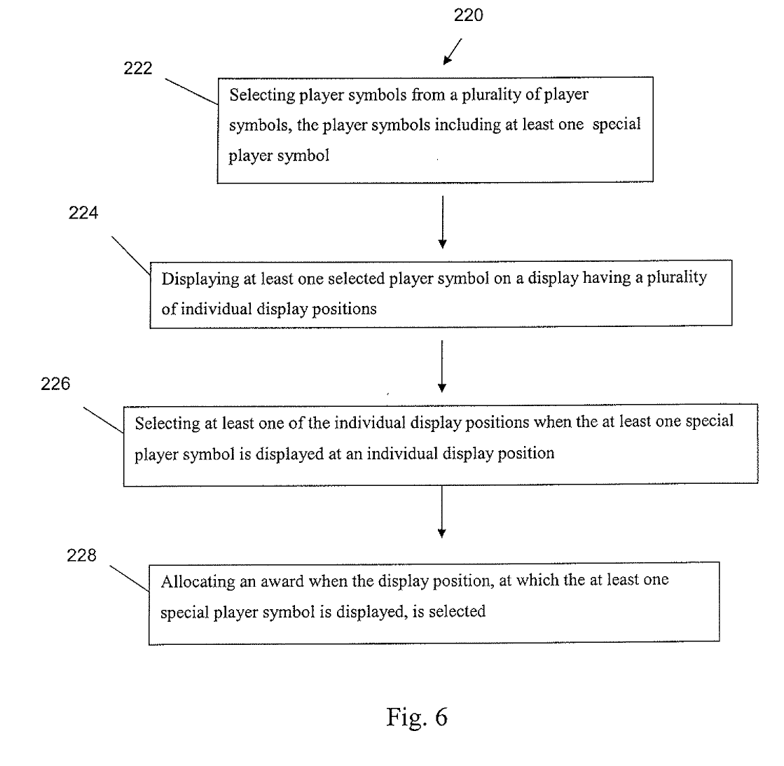

FIG. 5 shows a gaming system 200 in accordance with an alternative embodiment. The gaming system 200 includes a network 201, which for example may be an Ethernet network, a LAN or a WAN. In this example, three banks 203 of two gaming machines 202 are connected to the network 201. The gaming machines 202 provide a player operable interface and may be the same as the gaming machines 10,100 shown in FIGS. 2 and 3, or may have simplified functionality depending on the requirements for implementing game play. While banks 203 of two gaming machines are illustrated in FIG. 5, banks of one, three or more gaming machines are also envisaged.

One or more displays 204 may also be connected to the network 201. The displays 204 may, for example, be associated with one or more banks 203 of gaming machines. The displays 204 may be used to display representations associated with game play on the gaming machines 202, and/or used to display other representations, for example promotional or informational material.

In a thick client embodiment, a game server 205 implements part of the game played by a player using a gaming machine 202 and the gaming machine 202 implements part of the game. With this embodiment, as both the game server 205 and the gaming machine 202 implement part of the game, they collectively provide a game controller. A database management server 206 may manage storage of game programs and associated data for downloading or access by the gaming devices 202 in a database 206A. Typically, if the gaming system enables players to participate in a Jackpot game, a Jackpot server 207 will be provided to monitor and carry out the Jackpot game.

In a variation of the above thick client embodiment, the gaming machine 202 may implement the game, with the game server 205 functioning merely to serve data indicative of a game to the gaming machine 202 for implementation.

With this implementation, a data signal containing a computer program usable by the client terminal to implement the gaming system may be transferred from the game server to the client terminal, for example in response to a request by the client terminal.

In a thin client embodiment, the game server 205 implements most or all of the game played by a player using a gaming machine 202 and the gaming machine 202 essentially provides only the player interface. With this embodiment, the game server 205 provides the game controller. The gaming machine will receive player instructions, and pass the instructions to the game server which will process them and return game play outcomes to the gaming machine for display. In a thin client embodiment, the gaming machines could be computer terminals, e.g. PCs running software that provides a player interface operable using standard computer input and output components.

Servers are also typically provided to assist in the administration of the gaming system 200, including for example a gaming floor management server 208 and a licensing server 209 to monitor the use of licenses relating to particular games. An administrator terminal 210 is provided to allow an administrator to monitor the network 201 and the devices connected to the network.

The gaming system 200 may communicate with other gaming systems, other local networks such as a corporate network, and/or a wide area network such as the Internet, for example through a firewall 211.

A loyalty program server 212 may also be provided.

Persons skilled in the art will appreciate that in accordance with known techniques, functionality at the server side of the network may be distributed over a plurality of different computers. For example, elements may be run as a single “engine” on one server or a separate server may be provided. For example, the game server 205 could run a random number generator engine. Alternatively, a separate random number generator server could be provided.

An example of a specific implementation of the gaming system will now be described in relation to a stand alone gaming machine 40, 100, although it will be understood that implementation may also be carried out using other gaming system architectures such as a network architecture of the type shown in FIG. 5.

In the present embodiment, the gaming system 10 is arranged to display virtual symbols using a video graphical display device, although it will be understood that other arrangements are envisaged, such as reels with the symbols disposed thereon. The symbols in this example are in the form of representations of dice numbers.

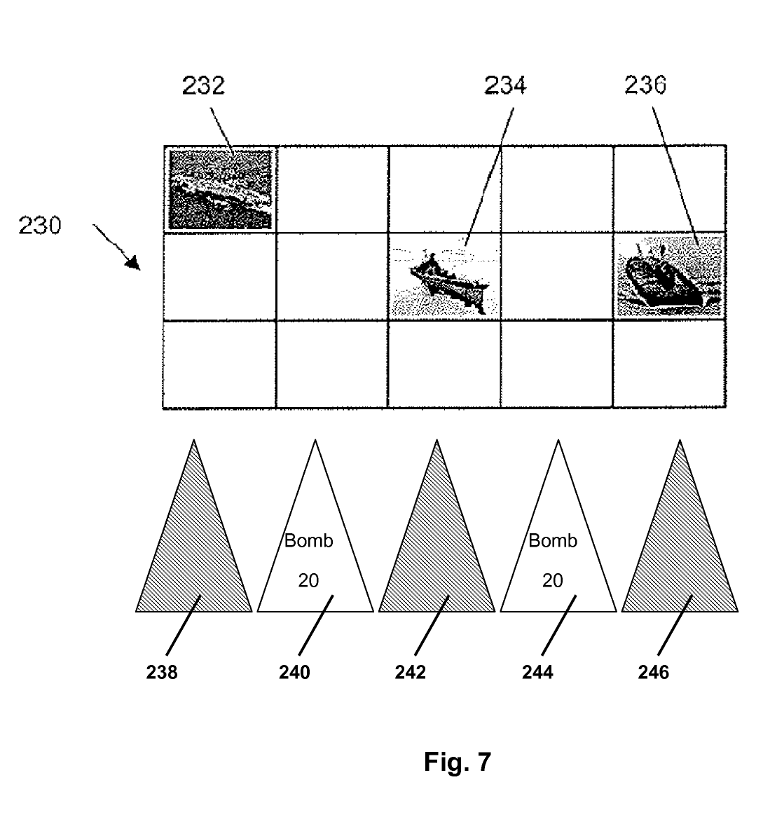

FIG. 6 illustrates a method 220 of gaming according to a specific embodiment of the present invention. The method includes step 222 of selecting player symbols form a plurality of player symbols. The plurality of player symbols includes at least one special player symbol. The selected player symbols are then displayed at the individual display positions.

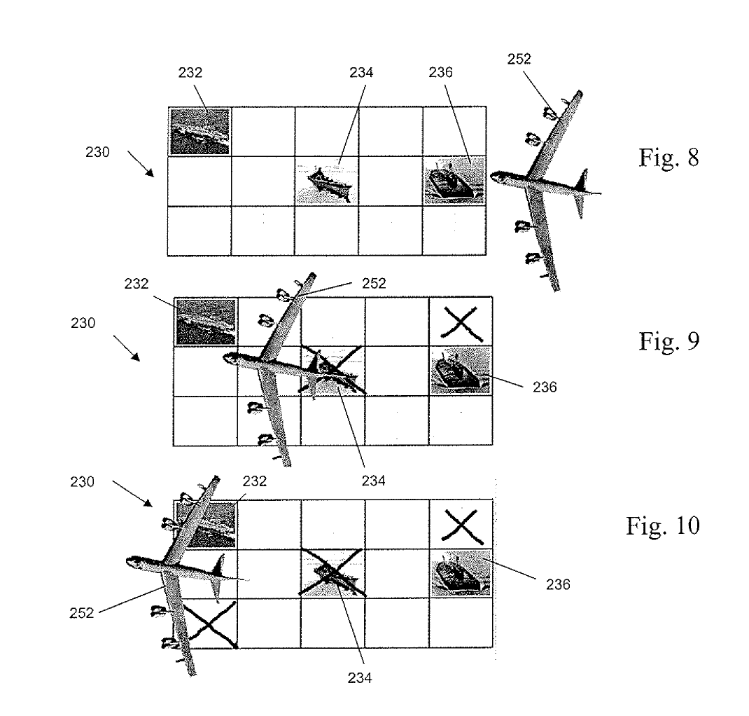

FIG. 7 schematically show such displays. The shown display 230 has 15 individual display positions which are ordered in an array of five columns and three rows. A person skilled in the art will appreciate that alternatively the display may have any other number of display positions ordered in any other way.

The step 222 may include selecting one player symbol for each individual display position. Alternatively, the step 222 may include selecting one player symbol, which is not a special player symbol, for display at each individual player position and selecting one or more special player symbols for additional display at one or more of the individual display positions.

The display 230 shows in this example three special player symbols 232, 234 and 236, which are presented in the form of military ships. Step 236 includes selecting at least one of the individual display positions of the display 230 when the at least one special player symbol is displayed at an individual display position.

The method 220 also includes step 226 of selecting at least one of the display positions of the display 230 when at least one special player symbol is displayed. Control elements, which in this example are provided in the form control buttons 238, 240, 242, 244 and 246, are positioned adjacent the display 230 and positioned below respective rows of the display 230.

In this example the player has the option to activate a display position selector by pressing control buttons 238, 242 and/or 246, which are associated with respective rows in which the special player symbols 232, 234 and 236 respectively, are displayed. In this example the control buttons 238, 242 and 246 are illuminated to indicate that the player may activate the display position selector by pressing the respective control buttons.

In a variation of the described embodiment any other number of control elements may be positioned adjacent the display 230 or at any other suitable position. For example, a single control element, such as a single control button, may be arranged for activating or pre-activating the display position selector to select any one of the individual display position of the display 230.

In the above-described variation the player has the option to activate the display position selector after display of at least one special player symbol, such as symbols 232, 234 or 236. Alternatively, the method 220 may be arranged so that the player has the option to pre-activate the display position selector. For example, the player may be given the option to push anyone of the control buttons 238-246 prior to display of a special player symbol on the display 230. In this case the method 220 may be arranged so that, when a special player symbol is displayed at a display position for which the display position selector is pre-activated, one or more of the individual positions of the display 230 are automatically selected.

FIGS. 8-10 show the displays 230 and the special player symbols 232, 234 and 236. Further, a feature symbol 252 is illustrated. In this example, the feature symbol 252 is provided in the form of an airplane image, such as a military airplane.

In this example, the step 226 of selecting at least one individual display position includes an illustration of moving the feature symbol 252 across the display 230. FIGS. 8-10 show the display 230 and the feature symbol 252 with the feature symbol 252 being positioned at differing positions.

For example, if the player has activated or pre-activated the display position selector by pushing control button 246, one of the individual display positions of the right-hand column of the display 230 is then selected once the feature symbol 252 is positioned near-by or over that column. The individual display positions that are selected may be marked in the form of a projectile that may be dropped from the feature symbol 252 or may be marked in any other form. In the examples shown in FIGS. 9 and 10, the selected display positions are marked by an “X” symbol position at the selected display positions.

FIG. 10 shows the display 230 after the individual display positions have been selected (step 226) by the display position selector which was activated by pushing the control buttons 238, 242 and 246. In the shown example the display position of the special player symbol 234 was selected, while the special player symbols 232 and 236 were missed.

The method 220 also includes step 228 allocating a reward when an individual display position, at which the at least one special player symbol is displayed, is selected.

Consequently, a reward will be allocated because of the selection of the display position of the special player symbol 234 as shown in FIG. 10.

In this embodiment the reward is dependent on the type of special player symbol that is displayed and selected. Each special player symbol may be associated with a predefined value or Jackpot level. For example, the special player symbol 236 may be associated with higher value than the special player symbol 234, which in turn may have a higher value than the special player symbol 232. The reward may be given in the form of credit points which may be accumulated. Once a predefined number of win or credit points have been accumulated for the player, a particular Jackpot level may be reached or a Jackpot prize may be allocated to the player.

Although the invention has been described with reference to particular examples, it will be appreciated by those skilled in the art that the invention may be embodied in many other forms. For example, any number of player symbols may be selected and displayed. Further, the displays 230 shown on FIGS. 7-10 only displays special player symbols. It is to be appreciated, however, that additionally any number of other symbols, which are not special player symbols, may be displayed at anyone of the individual display positions. Rewards may be allocated for display of player symbols in a predefined winning combination. For example, such predefined winning combination may or may not include the special player symbols. The predefined winning combination of player symbols may include player symbols along win lines, which typically are imaginary lines through adjacent display positions. Further, the player may have the opportunity to purchase bets on individual player positions or win lines, which determine an award that is allocated when a winning combination is displayed.

In the claims which follow and in the preceding description of the invention, except where the context indicates otherwise due to express language or necessary implication, the word “comprise” or variations such as “comprises” or “comprising” is used in an inclusive sense, i.e. to specify the presence of the stated features but not to preclude the presence or addition of further features in various embodiments of the invention.

It will be appreciated by persons skilled in the art that numerous variations and/or modifications may be made to the invention as shown in the specific embodiments and/or aspects without departing from the spirit or scope of the invention as broadly described. The present embodiments and aspects are, therefore, to be considered in all respects as illustrative and not restrictive. Several embodiments are described above with reference to the drawings. These drawings illustrate certain details of specific embodiments that implement the systems and methods and programs of the present invention. However, describing the invention with drawings should not be construed as imposing on the invention any limitations associated with features shown in the drawings. The present invention contemplates methods, systems and program products on any electronic device and/or machine-readable media suitable for accomplishing its operations. Certain embodiments of the present invention may be implemented using an existing computer processor and/or by a special purpose computer processor incorporated for this or another purpose or by a hardwired system, for example.

Embodiments within the scope of the present invention include program products comprising machine-readable media for carrying or having machine-executable instructions or data structures stored thereon. Such machine-readable media can be any available media that can be accessed by a general purpose or special purpose computer or other machine with a processor. By way of example, such machine-readable media may comprise RAM, ROM, PROM, EPROM, EEPROM, Flash, CD-ROM or other optical disk storage, magnetic disk storage or other magnetic storage devices, or any other medium which can be used to carry or store desired program code in the form of machine-executable instructions or data structures and which can be accessed by a general purpose or special purpose computer or other machine with a processor. When information is transferred or provided over a network or another communications connection (either hardwired, wireless, or a combination of hardwired or wireless) to a machine, the machine properly views the connection as a machine-readable medium. Thus, any such a connection is properly termed a machine-readable medium. Combinations of the above are also included within the scope of machine-readable media. Machine-executable instructions comprise, for example, instructions and data which cause a general purpose computer, special purpose computer, or special purpose processing machines to perform a certain function or group of functions.

1. A gaming system comprising:
a player symbol selector arranged to select player symbols from a plurality of player symbols, the player symbols including at least one special player symbol;
a display having a plurality of individual display positions for displaying at least one selected player symbol;
a display position selector arranged to select at least one of the individual display position when the at least one special player symbol is displayed; and
a reward allocator arranged to allocate a reward when the display position selector selects an individual display position at which the at least one special player symbol is displayed.

2. The gaming system of claim 1 wherein the display position selector is arranged for activation by a player when the at least one special player symbol is displayed.

3. The gaming system of claim 1 wherein the display position selector is arranged for pre-activation by a player prior to display of the at least one special player symbol, so that, when the at least one special player symbol is displayed, the display position selector automatically selects an individual display position.

4. The gaming system of claim 1 wherein the display position selector is activated or pre-activated by an event.

5. The gaming system of claim 1 wherein the at least one special player symbol is a Jackpot symbol.

6. The gaming system of claim 1 wherein the at least one special player symbol is a Jackpot level symbol.

7. The gaming system of claim 1 wherein the reward allocator is arranged to allocate a Jackpot or Jackpot level when the at least one special player symbol is displayed at a display position and that display position is selected by the display position selector.

8. The gaming system of claim 1 wherein the display position selector is arranged to select any one of the individual display positions.

9. The gaming system of claim 1 wherein the display position selector is arranged so that the player can choose a group of display positions within which the display position selector selects an individual display position.

10. The gaming system of claim 8 wherein the display comprises an array of individual display positions and wherein the gaming system is arranged so that a player has the opportunity to activate or pre-activate the display position selector and choose one or more of the columns or rows of the array of display positions from which the display position selector selects the individual display position.

11. The gaming system of claim 1 wherein the display position selector is arranged for activation or pre-activate by operating a manual control.

12. The gaming system of claim 1 comprising a plurality of manual controls that are accessible to a player and that are associated with respective groups of individual display positions.

13. The gaming system of claim 1 wherein the gaming system is arranged so that activation or pre-activation of the display position selector can be purchased by a player.

14. The gaming system of claim 1 wherein the display is arranged to display a feature symbol when the display position selector is activated or pre-activated and when the at least one special player feature symbol is displayed.

15. The gaming system of claim 1 wherein the display is arranged so that, when the display position selector selects an individual display position, a marking symbol is displayed at that display position.

16. A method of gaming comprising:
selecting player symbols from a plurality of player symbols, the player symbols including at least one special player symbol;
displaying at least one selected player symbol on a display having a plurality of individual display positions;
selecting at least one of the individual display position when the at least one special player symbol is displayed; and
allocating a reward when an individual display position, at which the at least one special player symbol is displayed, is selected.

17. The method of claim 16 wherein selecting at least one individual display position comprises activation of a display position selector by a player when the at least one special player symbol is displayed.

18. The method of claim 16 wherein selecting at least one individual display position comprises pre-activation of the display position selector by a player prior to display of the at least one special player symbol, so that, when the at least one special player symbol is displayed, the display position selector automatically selects an individual display position.

18. The method of claim 16 wherein selecting at least one individual display position comprises activation or pre-activation of the display position selector by an event.

20. The method of claim 16 wherein the at least one special player symbol is a Jackpot symbol.

21. The method of claim 16 wherein the at least one special player symbol is a Jackpot level symbol.

22. The method of claim 16 wherein a Jackpot or Jackpot level is allocated when the at least one special player symbol is displayed and the respective display position is selected by the display position selector.

23. The method of claim 16 wherein selecting at least one display position comprises selecting any one of the individual display positions.

24. The method of claim 16 wherein selecting at least one display position display position comprises choosing a group of display positions within which the display position selector will select the individual display position when the at least one special player symbol is displayed within that group of individual display positions.

25. The method of claim 16 further comprising displaying a feature symbol when the at least one special player symbol is displayed.

26. The method of claim 16 further comprising displaying a marking symbol at the at least one selected individual display position.

27. A computer readable medium having a computer program including computer readable program code for instructing a computer and arranged so that, when loaded in the computer, the computer operates in accordance with a gaming system comprising:
a player symbol selector arranged to select player symbols from a plurality of player symbols, the player symbols including at least one special player symbol;
a display having a plurality of individual display positions for displaying at least one selected player symbol;
a display position selector arranged to select at least one of the individual display position when the at least one special player symbol is displayed; and
a reward allocator arranged to allocate a reward when the display position selector selects an individual display position at which the at least one special player symbol is displayed.

28. A computer that is arranged for operation in accordance in accordance with a gaming system comprising:
a player symbol selector arranged to select player symbols from a plurality of player symbols, the player symbols including at least one special player symbol;
a display having a plurality of individual display positions for displaying at least one selected player symbol;
a display position selector arranged to select at least one of the individual display position when the at least one special player symbol is displayed; and
a reward allocator arranged to allocate a reward when the display position selector selects an individual display position at which the at least one special player symbol is displayed.
